(19) United States
(12) Patent Application Publication
(10) Pub. No.: US 2023/0135980 A1
(43) Pub. Date: May 4, 2023

(54) INFORMATION PROCESSING DEVICE, METHOD, AND STORAGE MEDIUM FOR STORING METHOD

(71) Applicant: CANON KABUSHIKI KAISHA, Tokyo (JP)

(72) Inventor: Mitsuru Konji, Kanagawa (JP)

(21) Appl. No.: 17/974,793

(22) Filed: Oct. 27, 2022

(30) Foreign Application Priority Data
Nov. 2, 2021 (JP) 2021-179731

(51) Int. Cl. H04W 48/16; H04W 8/00; H04W 48/20

(52) U.S. Cl. CPC H04W 48/16; H04W 8/005; H04W 48/20

(57) ABSTRACT

An information processing device executes first process for a communication, between an information processing device and a communication device, for establishing, between an access point that is different from the communication device and the communication device, a wireless connection by a predetermined connection method. Information of the access point is transmitted to the communication device in the communication. In a case where there is no external access point that is different from the information processing device and to which the information processing device is able to connect, information processing device is set to operate as an access point and second process for transmitting information of the access point as which the information processing device is operating is executed.

### BACKGROUND OF THE INVENTION

### Field of the Invention

The present invention relates to an information processing device, method, and a storage medium for storing a method for enabling an establishment of a wireless connection with an external device.

### Description of the Related Art

A technique in which an information processing device, such as a personal computer (PC), connects a communication device, such as a printer, and an access point by transmitting information related to the access point to the communication device is known.

### SUMMARY OF THE INVENTION

The present invention provides an information processing device, method, and a storage medium for storing a method for improving convenience of a function of connecting a communication device and an access point.

The present invention in one aspect provides a method comprising: executing first process for a communication, between an information processing device and a communication device, for establishing, between an access point that is different from the communication device and the communication device, a wireless connection by a predetermined connection method, wherein information of the access point is transmitted to the communication device in the communication; in a case where there is no external access point that is different from the information processing device and to which the information processing device is able to connect, setting the information processing device to operate as an access point and executing second process for transmitting information of the access point as which the information processing device is operating.

According to the present invention, it is possible to improve convenience of a function of connecting a communication device and an access point.

Further features of the present invention will become apparent from the following description of exemplary embodiments with reference to the attached drawings.

### BRIEF DESCRIPTION OF THE DRAWINGS

FIG. 1 is a diagram illustrating configurations of an information processing device and a communication device.

FIG. 2 is a flowchart for explaining a process to be executed by the information processing device.

FIG. 3 is a diagram illustrating a screen for capturing a QR code.

FIG. 4 is a flowchart for explaining a process to be executed by the information processing device.

FIG. 5 is a diagram illustrating a user interface screen.

FIG. 6 is a diagram illustrating a user interface screen.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

It is desired to improve convenience of a function of connecting a communication device and an access point by transmitting information for connecting with the access point to the communication device.

According to the present disclosure, it is possible to improve convenience of a function of connecting a communication device and an access point.

A description will be given for an information processing device 101 and a communication device 151, which are included in a communication system of the present embodiment. Although a smartphone exemplifies the information processing device 101 in the present embodiment, the present invention is not limited to this. For example, various devices, such as a portable terminal, a personal computer (PC), a tablet terminal, a Personal Digital Assistant (PDA), and a digital camera, can be adopted as the information processing device 101. Although a printer exemplifies the communication device 151, the present invention is not limited to this, and various devices can be adopted so long as the devices are capable of performing wireless communication with the information processing device 101. For example, in case of a printer, an inkjet printer, a full-color laser beam printer, a monochrome printer, or the like can be adopted. Not only a printer but also a copy machine, a fax machine, a portable terminal, a smartphone, a notebook PC, a tablet terminal, a PDA, a digital camera, a music playback device, a television, a smart speaker, or the like can also be adopted. A multifunction peripheral, which includes a plurality of functions, such as a copy function, a fax function, and a print function, can also be adopted.

In the present embodiment, if the information processing device 101 supports a function called Wi-Fi Easy Connect® (hereinafter, WEC), the information processing device 101 can execute that function. WEC is a function of executing a network setup of another device using a Device Provisioning Protocol (hereinafter, DPP), which has been established by the Wi-Fi Alliance. Specifically, a network setup of another device is a process for connecting another device to an access point that forms a network.

In WEC, communication is performed between a device that operates as a “Configurator” (hereinafter referred to as Configurator device) and a device that operates as an “Enrollee” (hereinafter referred to as Enrollee device). A Configurator device obtains Bootstrapping information from an Enrollee device. The Bootstrapping information includes, for example, identification information (such as a MAC address) of the Enrollee device, public key information used for performing secure communication with the Enrollee device, and the like. In the present embodiment, the Bootstrapping information will be described as “WEC-related information.” Other information may be used as the WEC-related information. Then, the Configurator device executes wireless communication with the Enrollee device using the obtained Bootstrapping information. Specifically, for example, the Configurator device encrypts a protocol key using a public key that is included in the Bootstrapping information and transmits the encrypted protocol key to the Enrollee device. The Configurator device encrypts a common key (shared key) based on the encrypted protocol key and transmits, to the Enrollee device, information that has been encrypted using that common key. Specifically, the information transmitted here is, for example, information for connecting to an access point. Then, the Enrollee device establishes a wireless connection with the access point using the connection information received from the Configurator device. A description will be given assuming that, in a network setup process by WEC according to the present embodiment, the information processing device 101 that supports WEC operates as the Configurator device. A description will be given also assuming that the communication device 151 that supports WEC operates as the Enrollee device.

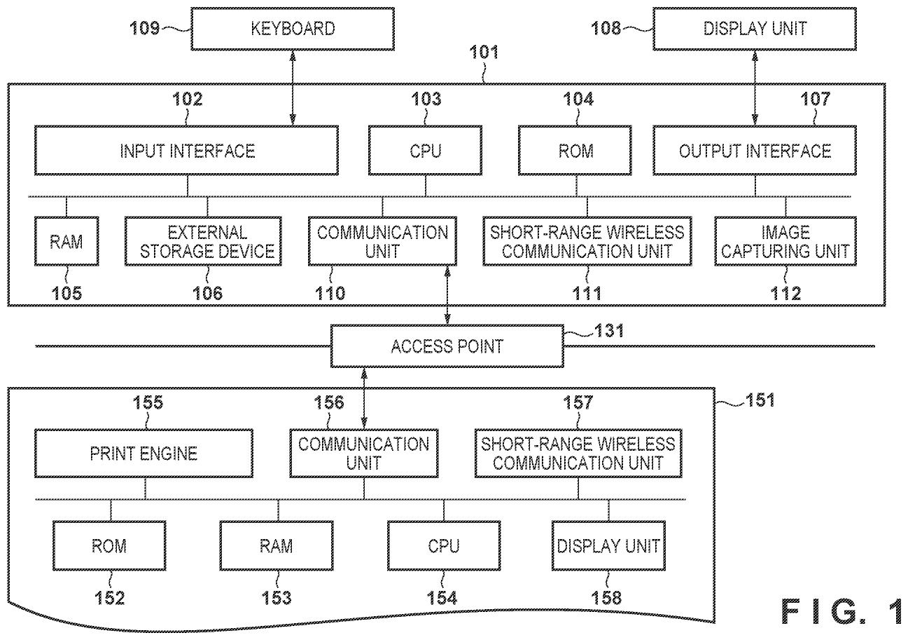

First, a description will be given for configurations of the information processing device 101 of the present embodiment and the communication device 151, which can communicate with the information processing device 101 of the present embodiment, with reference to a block diagram of FIG. 1. Although a description will be given using the following configurations as examples in the present embodiment, the present invention is not limited to the illustrated functions. The devices include, as appropriate, configurations that correspond to functions, which can be implemented in devices that can be adopted as devices capable of communicating with each other.

The information processing device 101 includes an input interface 102, a CPU 103, a ROM 104, a RAM 105, an external storage device 106, an output interface 107, a display unit 108, a communication unit 110, and a short-range wireless communication unit 111. The CPU 103, the ROM 104, the RAM 105, and the like form a computer of the information processing device 101 for executing a program.

The input interface 102 is an interface for receiving data input or an operation instruction from a user when an operation unit, such as a keyboard 109, is operated. The operation unit may be a physical keyboard, a physical button, and the like and may be a software keyboard, a software button, and the like, which are displayed on the display unit 108. That is, the input interface 102 may receive input from the user via the display unit 108.

The CPU 103 is a system control unit and controls the entire information processing device 101. The ROM 104 stores fixed data, such as control programs to be executed by the CPU 103, data tables, and an embedded operating system (hereinafter referred to as OS) program. In the present embodiment, the respective control programs stored in the ROM 104 perform control for executing software for scheduling, task switching, interrupt processing, and the like under the control of the embedded OS stored in the ROM 104.

The RAM 105 is configured by a Static Random Access Memory (SRAM), which needs a backup power supply, or the like. Since data is held by a primary battery for data backup (not illustrated), the RAM 105 can store important data, such as program control variables, without volatilization. A memory area for storing setting information of the information processing device 101, management data of the information processing device 101, and the like is also provided in the RAM 105. The RAM 105 is also used as a main memory and a work memory of the CPU 103.

The external storage device 106 stores an application program (hereinafter, referred to as setting application) for executing a network setup of the communication device 151, a print information generation program for generating print information that can be interpreted by the communication device 151, and the like. The setting application is an application program for performing setting of an access point to which the communication device 151 is to be connected by WEC or the like. The setting application may have functions other than a network setup. For example, the setting application may be provided with a function of causing the communication device 151 to execute printing, a function of scanning a document set on a document table of the communication device 151, a function of confirming a state of the communication device 151, and the like. For example, the setting application is stored in the external storage device 106 by being installed from an external server by Internet communication via the communication unit 110. The external storage device 106 stores various programs, such as an information transmission/reception control program that transmits and receives information to and from the communication device 151 connected via the communication unit 110, and various kinds of information used by these programs.

The output interface 107 is an interface for controlling the display unit 108 to display data or notify a state of the information processing device 101. The display unit 108 is configured by light emitting diodes (LED), a liquid crystal display (LCD), or the like and displays data and notifies a state of the information processing device 101. An image capturing unit 112 is, for example, a camera for capturing an outside.

The communication unit 110 is configured to execute data communication by being connected to a device, such as the communication device 151 or an access point 131. For example, the communication unit 110 can be connected to an access point (not illustrated) in the communication device 151. The communication unit 110 also includes an access point for connecting to a device, such as the communication device 151, as an access point inside the information processing device 101. A function of activating this access point is commonly called tethering. A communication unit 156 of the communication device 151 can be connected to this access point. The information processing device 101 operates as an access point by the communication unit 110 enabling this access point. The information processing device 101 and the communication device 151 can communicate with each other by the access points in the communication unit 110 and the communication device 151 being connected. When the communication unit 110 of the information processing device 101 is connected to the Internet, the communication device 151 can also use the Internet via the information processing device 101. The communication unit 110 may communicate directly with the communication device 151 by wireless communication or may communicate via an external device, which is external to the information processing device 101 and the communication device 151. The external device includes an external access point (such as the access point 131), which is external to the information processing device 101 and the communication device 151, or a device other than an access point that can relay communication. In the present embodiment, it is assumed that a wireless communication method used by the communication unit 110 is WirelessFidelity® (Wi-Fi), which is a communication standard conforming to the IEEE 802.11 series. It is assumed that the above-described WEC is executed by communication by the communication unit 110. The access point 131 may be, for example, a device, such as a wireless LAN router, or the like. In the present embodiment, a method by which the information processing device 101 and the communication device 151 directly connect without going through an external access point is called a direct connection method. A method by which the information processing device 101 and the communication device 151 connect via an external access point is called an infrastructure connection method.

The short-range wireless communication unit 111 is configured to wirelessly connect with a device, such as the communication device 151, at a short distance to execute data communication and performs communication by a communication method that is different from the communication unit 110. The short-range wireless communication unit 111 can be connected, for example, to a short-range wireless communication unit 157 in the communication device 151. The communication method includes, for example, Near Field Communication (NFC), Bluetooth® Classic, Bluetooth Low Energy (BLE), Wi-Fi Aware, and the like.

In the present embodiment, the information processing device 101 executes WEC by the OS of the information processing device 101 based on an instruction for executing a network setup process by the setting application.

The communication device 151 is a communication device of the present embodiment. The communication device 151 includes a ROM 152, a RAM 153, a CPU 154, a print engine 155, the communication unit 156, and the short-range wireless communication unit 157. The ROM 152, the RAM 153, the CPU 154, and the like form a computer of the communication device 151 for executing a program.

The communication unit 156 includes an access point for connecting to an external device, such as the information processing device 101, as an access point inside the communication device 151. This access point can connect to the communication unit 110 of the information processing device 101. The communication device 151 operates as an access point by the communication unit 156 enabling this access point. The communication unit 156 may be wirelessly connected to the information processing device 101 directly or may be wirelessly connected via the access point 131. In the present embodiment, it is assumed that a wireless communication method used by the communication unit 156 is a communication standard conforming to the IEEE 802.11 series. Further, it is assumed that if the communication device 151 supports WEC, the above-described WEC is executed by communication by the communication unit 156. The communication unit 156 may include hardware that functions as an access point or may be operated as an access point by software for causing it to function as an access point.

The communication device 151 of the present embodiment can be operated in an infrastructure mode and a Peer to Peer (P2P) mode as modes for performing communication using the communication unit 156.

The infrastructure mode is a mode in which the communication device 151 communicates with another device, such as the information processing device 101, via an external device (e.g., the access point 131) that forms a network. A connection to an external access point established by the communication device 151 operating in the infrastructure mode is called an infrastructure connection. In the present embodiment, the communication device 151 operates as a slave, and the external access point operates as a master in the infrastructure connection. The master in the present embodiment is a device for determining a communication channel used in a network to which the master belongs, and the slave is a device that, instead of determining a communication channel used in a network to which the slave belongs, uses a communication channel determined by the master.

The P2P mode is a mode in which the communication device 151 directly communicates with another device, such as the information processing device 101, without going through an external device that forms a network. In the present embodiment, it is assumed that the P2P mode includes an AP mode in which the communication device 151 operates as an access point. It is also assumed that connection information (an SSID and a password) of an access point that is enabled in the communication device 151 in the AP mode can be optionally set by the user. The P2P mode, for example, may include a Wi-Fi Direct (WFD) mode for the communication device 151 to communicate by WFD. Which of the plurality of devices that support WFD operates as the master, for example, is determined in accordance with a sequence called a Group Owner Negotiation. The master may be determined without the Group Owner Negotiation being executed. A device that supports WFD and serves as the master is specifically called a Group Owner. A direct connection with another device established by the communication device 151 operating in the P2P mode is called a direct connection. In the present embodiment, the communication device 151 operates as the master, and another device operates as a slave in the direct connection.

Furthermore, in the present embodiment, the communication device 151 can operate in a network setup mode, which is a mode for executing a network setup of the communication device 151, by receiving a predetermined operation from the user. In a case of operating in the network setup mode, the communication device 151 uses the communication unit 156 to operate as an enabled setup access point while operating in the network setup mode. The setup access point is an access point that is different from the access point that is enabled in the above-described AP mode. It is assumed that an SSID of the setup access point includes a predetermined character string that can be recognized by the setting application of the information processing device 101. It is also assumed that the setup access point is an access point that does not require a password for connection. It is assumed that the communication device 151 operating in the network setup mode uses a predetermined communication protocol (setup communication protocol) in the communication with the information processing device 101 connected to the setup access point. Specifically, the setup communication protocol is, for example, a Simple Network Management Protocol (SNMP). After a predetermined period of time has elapsed from a start of operation in the network setup mode, the communication device 151 stops operating in the network setup mode and disables the setup access point. This is because, as described above, the setup access point is an access point that does not require a password and, therefore, if it is enabled for a long time, there is an increased possibility that a connection may be requested from an inappropriate device. The setup access point may be an access point that requires a password. In such a case, it is assumed that the password used to connect to the setup access point is a fixed password, which is already known by the setting application (and cannot be changed by the user).

Furthermore, in the present embodiment, the communication device 151 can operate in a mode for executing a network setup for the communication device 151 with a communication protocol that is different from a setup communication protocol by receiving a predetermined operation from the user. In the present embodiment, it is assumed that a communication protocol that is different from the setup communication protocol is the above-described DPP and a mode thereof is referred to as a DPP mode. When a network setup request by the DPP is received from the information processing device 101 while the communication device 151 is operating in the DPP mode, a network setup by the DPP is executed. Therefore, in other words, the DPP mode is a mode for waiting for a network setup request by the DPP. Further, after a timeout period for the DPP mode has elapsed from a start of operation in the DPP mode, the communication device 151 stops operating in the DPP mode and stops waiting for a network setup request by the DPP. The timeout period for the DPP mode may be the same as the timeout period for the network setup mode or may be longer or shorter than the timeout period for the network setup mode. In the present embodiment, the communication device 151 starts operating in the DPP mode based on an operation for displaying a two-dimensional code for causing the information processing device 101 to obtain WEC-related information being performed. In the present embodiment, the operation for displaying a two-dimensional code specifically is, for example, a press of a start button on a screen. However, a timing and a condition under which an operation in the DPP mode is started are not limited to this. For example, an operation in the DPP mode may be started based on an operation in the network setup mode being started or an operation for starting an operation in the network setup mode being performed.

The short-range wireless communication unit 157 is configured to wirelessly connect with a device, such as the information processing device 101, at a short distance and can be connected to the short-range wireless communication unit 111 in the information processing device 101, for example. The communication method includes, for example, NFC, Bluetooth Classic, BLE, Wi-Fi Aware, and the like.

The RAM 153 is configured by an SRAM, which needs a backup power supply, or the like. Since data is held by a primary battery for data backup (not illustrated), the RAM 153 can store important data, such as program control variables, without volatilization. A memory area for storing setting information of the communication device 151, management data of the communication device 151, and the like is also provided in the RAM 153. The RAM 153 is also used as a main memory and a work memory of the CPU 154, is used as a reception buffer for temporarily storing print information received from the information processing device 101 and the like, and stores various kinds of information.

The ROM 152 stores fixed data, such as control programs to be executed by the CPU 154, data tables, and an OS program. In the present embodiment, the respective control programs stored in the ROM 152 perform control for executing software, such as scheduling, task switching, and interrupt processing, under the control of the embedded OS stored in the ROM 152. The CPU 154 is a system control unit and controls the entire communication device 151.

A print result is outputted by an image being formed on a printing medium, such as paper, by a printing agent, such as ink, being applied onto the printing medium based on information stored in the print engine 155 or the RAM 153 or a print job received from the information processing device 101 or the like. It is necessary to use a communication method capable of high-speed communication for communication of print jobs since the amount of data of a print job transmitted from the information processing device 101 or the like is, in general, large. Therefore, the communication device 151 receives print jobs via the communication unit 156, which is capable of communicating at a higher speed than the short-range wireless communication unit 157. A display unit 158 is, for example, a panel and displays data as well as notifies a state of the communication device 151. The communication device 151 may be mounted with a memory, such as an external HDD or an SD card, as an optional device, and the information stored in the communication device 151 may be stored in that memory.

In the present embodiment, the information processing device 101 may further include a barcode reading control unit (not illustrated). The barcode reading control unit obtains encoded code information by analyzing an image captured by the image capturing unit 112, which is, for example, a camera. The barcode reading control unit executes a process for analyzing code information, such as a barcode, a two-dimensional code, or a QR code®.

The communication device 151 may also include a barcode generation control unit. Although not illustrated in FIG. 1, the barcode generation control unit is realized by, for example, the CPU 154 executing a program. The barcode generation control unit generates code information, such as a barcode, a two-dimensional code, or a QR code, and the display unit 158 executes control for displaying the generated code information. The generated code information is, for example, a two-dimensional code for causing the information processing device 101 to obtain the WEC-related information. The display unit 158 may be configured so as to be capable of displaying a software button or the like as an interface for input from the user.

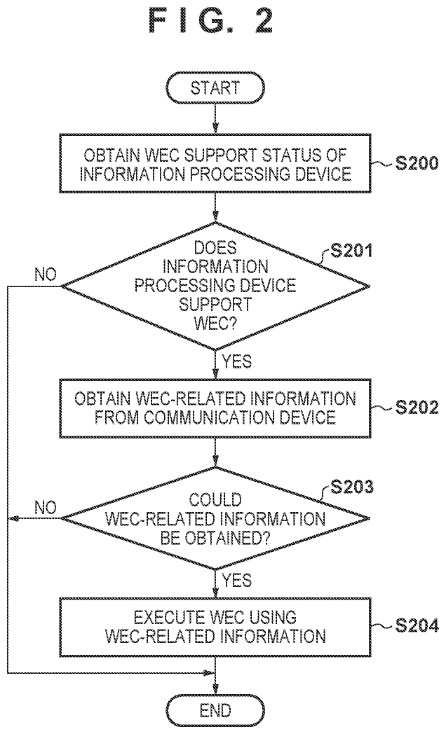

FIG. 2 is a flowchart illustrating a process to be executed by the information processing device 101 in the network setup process. The flowchart illustrated in FIG. 2 is realized by, for example, the CPU 103 reading the setting application stored in the ROM 104, the external storage device 106, or the like to the RAM 105 and then executing the setting application. Further, the flowchart illustrated in FIG. 2 is started in response to a predetermined operation for a network setup (hereinafter, referred to as setting operation) being performed on a screen displayed by the setting application.

In step S200, the CPU 103 confirms whether the information processing device 101 supports WEC. The confirmation here is performed, for example, by the setting application querying the OS via an Application Programming Interface (API) provided by the OS and then the OS returning a WEC support status of the information processing device 101 to the setting application via the API.

In step S201, the CPU 103 determines whether or not the information processing device 101 supports WEC based on a confirmation result obtained in step S200. If it is determined that the information processing device 101 does not support WEC, the flowchart of FIG. 2 is terminated. On the other hand, if it is determined that the information processing device 101 supports WEC, the process proceeds to step S202.

In step S202, the CPU 103 obtains WEC-related information necessary for WEC from the communication device 151. For example, the WEC-related information is obtained by the communication device 151 displaying a QR code that corresponds to the WEC-related information on the display unit 158 and then the image capturing unit 112 of the information processing device 101 reading that QR code.

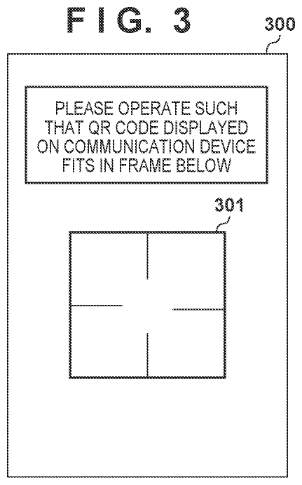

FIG. 3 is a diagram illustrating an example of a screen for capturing a QR code displayed by the setting application. A frame 301 is displayed on a screen 300 for capturing a QR code, and an image that is being captured by the image capturing unit 112, which is provided in the information processing device 101, is displayed on the screen 300. Images are captured in real time by the image capturing unit 112, and the user operates the information processing device 101 so that a QR code displayed by the communication device 151 fits in the frame 301. When it is detected that the QR code fits in the frame 301, the CPU 103 analyzes the QR code and obtains WEC-related information.

In step S203, the CPU 103 determines whether or not the WEC-related information has been obtained. If it is determined that the WEC-related information has not been obtained, the flowchart of FIG. 2 is terminated. On the other hand, if it is determined that WEC-related information has been obtained, the process proceeds to step S204.

In step S204, the CPU 103 executes WEC using the obtained WEC-related information and then terminates the flowchart of FIG. 2. The execution of WEC is realized by the OS being requested to execute WEC by the setting application. In other words, the setting application does not directly execute WEC but, instead, makes a request for executing WEC to the OS as control for executing WEC.

For example, the CPU 103 starts an OS standard, WEC application program (hereinafter, WEC application) by instructing the OS to start the WEC application from the setting application. This causes the WEC application to run in the foreground and the setting application to run in the background. For example, an execution of an instruction corresponds to an instruction for executing WEC. Thus, the information processing device 101 displays a WEC start screen by the WEC application. The WEC application is a program that has been installed in advance in the information processing device 101 and is a program provided by an OS vendor of the information processing device 101. In addition, when the WEC application is activated, the WEC-related information obtained by the setting application is provided to the WEC application.

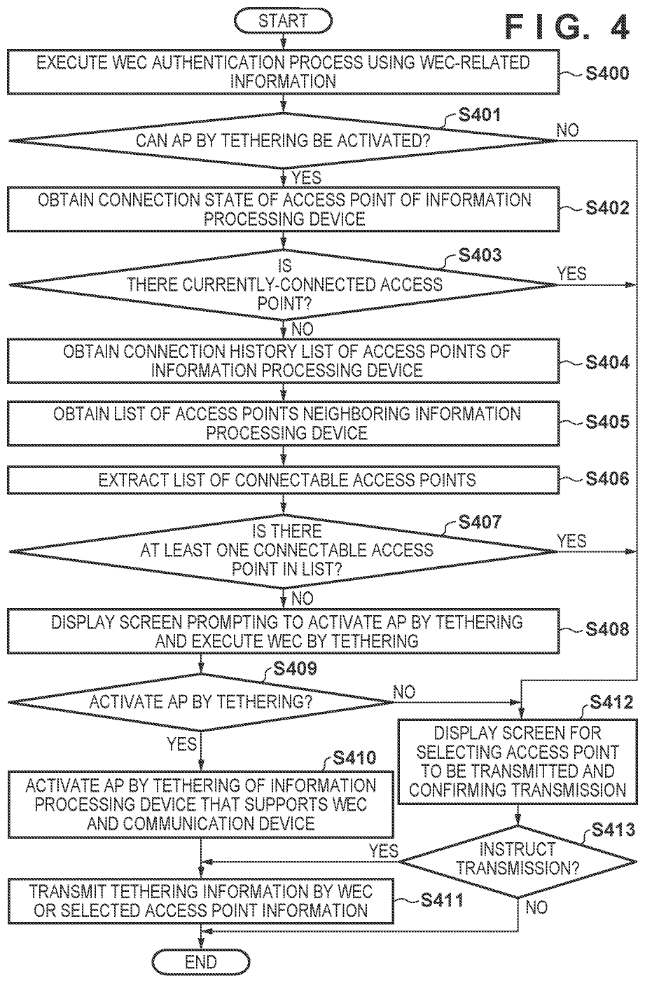

FIG. 4 is a flowchart illustrating a process to be executed by the information processing device 101 in the network setup process. The flowchart of FIG. 4 corresponds to a detailed process of step S204. FIG. 4 illustrates a flow of determining whether to activate an access point by tethering of the information processing device 101 and then executing WEC using tethering, among the processes executed by the OS of the information processing device 101 in the network setup process after the processing of FIG. 2. The flowchart illustrated in FIG. 4 is realized by, for example, the CPU 103 reading a program stored in the ROM 104, the external storage device 106, or the like to the RAM 105 and then executing the program.

In step S400, the CPU 103 executes a WEC authentication process using the WEC-related information. In step S400, an authentication process called a DPP Authentication is executed between the information processing device 101 and the communication device 151. In the DPP Authentication, communication between the information processing device 101 and the communication device 151 is authenticated by communicating authentication information, information used for encrypting information, and the like between the devices. Various kinds of information transmitted from the information processing device 101 in the communication in the DPP Authentication are encrypted based on the WEC-related information obtained in the processing illustrated in FIG. 2 by the information processing device 101.

Specifically, in the DPP Authentication, the information processing device 101 first transmits an Authentication Request as a network setup request by the DPP. In the present embodiment, since the communication device 151 operates in the DPP mode, which is a mode for waiting for an Authentication Request, the communication device 151 receives that Request transmitted from the information processing device 101. Upon receiving the Authentication Request, the communication device 151 attempts to decode the received Request using a decryption key that it is currently holding. If the decoding is successful, the communication device 151 authenticates communication with the information processing device 101 by transmitting an Authentication Response to the information processing device 101. If the information processing device 101 had not been able to encrypt the information correctly due to not having been able to obtain accurate WEC-related information, the decryption in the communication device 151 fails, and therefore, the authentication fails, and the Authentication Response is not transmitted. When the Authentication Response is received by the information processing device 101, the DPP Authentication is complete. Also, in the DPP Authentication, communication is executed using the DPP. Further, capabilities of the information processing device 101 and the communication device 151 are transmitted and received in the authentication process. Specific examples of the capabilities include authentication methods and frequency bands of connectable access points.

In step S401, the CPU 103 determines whether or not the information processing device 101 can activate an access point by tethering according to a function of the OS. If an activation of the access point by tethering is restricted by a development vendor of the information processing device or if mobile communication of the information processing device is unavailable, the access point cannot be activated by tethering. If it is determined that the access point cannot be activated by tethering, the process proceeds to step S412, which will be described later. On the other hand, if it is determined that the access point can be activated by tethering, the process proceeds to step S402.

In step S402, the CPU 103 attempts to obtain information of an access point to which the information processing device 101 is currently connected according to a function of the OS. Examples of access point information include an SSID and a password.

In step S403, the CPU 103 determines whether or not there is a currently-connected access point based on the result obtained in step S402. If currently-connected access point information can be obtained in step S402, it is determined that the information processing device 101 is currently connected to an access point, and the process proceeds to step S412. On the other hand, if the currently-connected access point information cannot be obtained, it is determined that there is no currently-connected access point, and the process proceeds to step S404.

In the communication by the access point that the information processing device 101 activates by tethering, mobile communication in which the information processing device 101 can use the Internet without using an access point is utilized. Generally, mobile communication requires a conclusion of a separate usage contract with a communication company, and there are cases where a communication charge is incurred. Therefore, when it is determined that there is a currently-connected access point, the process proceeds to step S412 so that an activation of an access point by tethering of the information processing device 101 is not executed. As a result, it is possible to avoid incurring a communication charge.

In step S404, the CPU 103 obtains a list (access point connection history list) of information of access points to which the information processing device 101 has connected in the past according to a function of the OS. By limiting what is obtained to access points to which a connection has been established in the past, not only SSIDs but also passwords can be obtained.

In step S405, the CPU 103 receives beacons of access points neighboring the information processing device 101 according to a function of the OS and then obtains a list of received access points. In step S406, access points that are included in the list obtained in step S405 and are neighboring the information processing device 101 are identified from the access point connection history list obtained in step S404.

In step S407, the CPU 103 determines whether there is at least one access point to which the information processing device 101 can currently be connected based on a result of the identification in step S406. If it is determined that there is at least one access point, the process proceeds to step S412. By causing the process to proceed to step S412 when there is at least one access point that satisfies the conditions—that is, an access point to which the information processing device 101 can currently be connected and has connected in the past—as described above, an activation of an access point by tethering of the information processing device 101 is not executed. As a result, it becomes unnecessary for the user to input a password and makes it possible to prevent the above-described communication charge from being incurred. On the other hand, if it is determined that there is no such access point, the process proceeds to step S408.

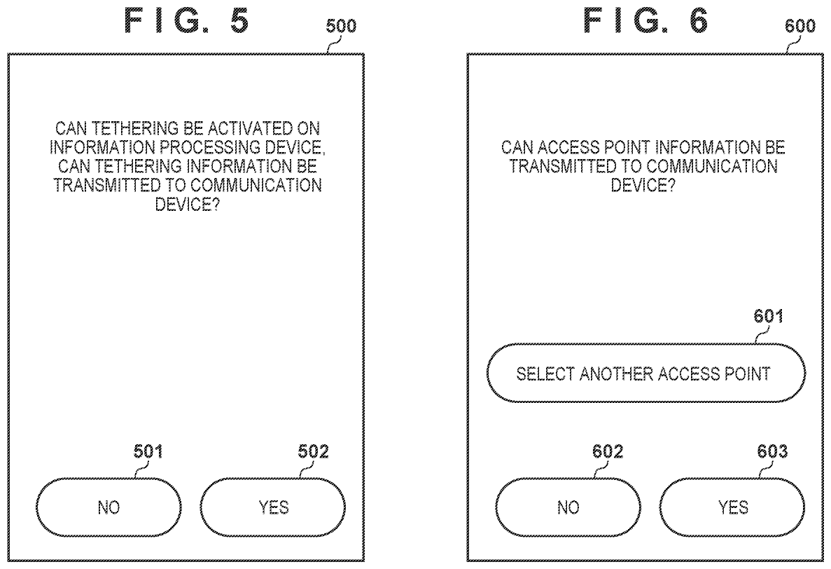

In step S408, the CPU 103 displays, on the display unit 108, a user interface (UI) screen prompting the user to activate an access point by tethering of the information processing device 101 according to a function of the OS and transmit information of the access point activated by tethering (hereinafter, tethering information) to the communication device 151 by WEC. Specifically, the tethering information is an SSID and a password for connecting to the access point activated by tethering. The tethering information may include information of a frequency band for connecting to the access point activated by tethering, information of an encryption method, and the like. FIG. 5 is a diagram illustrating an example of a UI screen 500 prompting to activate an access point by tethering and execute WEC using the tethering information in the present embodiment. When not activating an access point by tethering and not executing WEC, the user presses a button 501, and when activating an access point by tethering and executing WEC, the user presses a button 502. As described above, a communication charge is incurred by communication by the access point activated by tethering; therefore, by providing the button 501 for not activating the access point by tethering, the user can instruct not to activate the access point by tethering.

In step S409, the CPU 103 determines whether or not to activate an access point by tethering. For example, when a press of the button 502 is accepted, the CPU 103 determines to activate the access point by tethering and advances the process to step S410. On the other hand, when a press of the button 501 is accepted, the CPU 103 determines not to activate the access point by tethering and advances the process to step S412. When not activating the access point by tethering, the user selects an available access point and enters a password of the access point as necessary, and thereby WEC using the access point becomes available.

In step S410, the CPU 103 activates the access point by tethering with wireless settings that can be used in WEC and by the communication device 151 according to a function of the OS. For example, a method of encryption supported by WEC is WPA2 or WPA3 or the like, and a method of encryption that is not supported by WEC is less secure, for example, WPA or WEP. It is possible to prevent WEC from failing by activating the access point by tethering with a method of encryption that is supported by WEC. Further, in the present embodiment, wireless setting capabilities of the communication device 151 is obtained in the authentication process of step S400 as wireless settings that can be used by the communication device 151. Specifically, if the communication device 151 supports only WPA2 as the encryption method, that support information is obtained as capabilities in the authentication process. If WPA3 and WPA2 can be activated as the tethering encryption method of the information processing device 101 according to the present embodiment, WPA2 is selected based on the obtained capabilities of the communication device 151. Thus, it becomes possible to configure so as not to transmit information (tethering information) of the access point activated by tethering with wireless settings that are not supported by the communication device 151.

When proceeding from any of steps S401, S403, S407, and S409 to step S412, the CPU 103 displays a user interface screen in which the user can select access point information to be transmitted to the communication device 151 using WEC according to a function of the OS. FIG. 6 is a diagram illustrating an example of an access point selection screen. Areas 601, 602, and 603 are displayed on an access point selection screen 600. The area 601 is an area for changing an access point set as a target of setting by WEC. Before the area 601 is operated, the access point to which the information processing device 101 is currently connected is set as the target of setting by WEC. When the area 601 is selected, the CPU 103 displays a list of access points and newly sets an access point selected by the user from the list as the target of setting by WEC. The list of access points includes, for example, an access point found by the information processing device 101 by searching for an access point, an access point to which the information processing device 101 has connected, and the like. Further, if the information processing device 101 has not even once connected to the access point selected from the list, the information processing device 101 does not hold a password of the access point and so displays a screen for accepting a password input from the user. The inputted password is held by the OS as the connection information of the selected access point. The area 602 is an area for receiving an instruction for canceling an execution of WEC, and the area 603 is an area for receiving an instruction for executing WEC.

In step S413, the CPU 103 determines whether or not to transmit access point information to the communication device 151. For example, the CPU 103 determines whether the button 602 or the button 603 has been pressed on the access point selection screen 600. If the button 602 has been pressed, it is determined that the access point information is not to be transmitted to the communication device 151, and the process of FIG. 4 is terminated. On the other hand, if the button 603 has been pressed, it is determined that the access point information is to be transmitted to the communication device 151, and the process proceeds to step S411.

In step S411, the CPU 103 transmits the access point information determined as the transmission target in the process of FIG. 4 to the communication device 151 by WEC according to a function of the OS. That is, when the process proceeds from step S410 to step S411, in step S411, the CPU 103 transmits tethering information by WEC to the communication device 151. When the process proceeds from step S413 to step S411, the CPU 103 transmits access point information selected in step S412 by WEC to the communication device 151. Specifically, a process called a DPP Configuration is executed between the information processing device 101 and the communication device 151. In the DPP Configuration, the information processing device 101 transmits connection information for connecting to an access point activated by tethering or a selected access point, which is set as a target of setting by WEC, to the communication device 151 by WEC. The connection information includes an SSID and a password of the access point activated by tethering or the selected access point, which is set as a target of setting by WEC; information indicating the encryption method; and the like. In a case of the selected access point, the password transmitted at this time is information held by the OS when a connection between the information processing device 101 and the access point was established. The password of the access point activated by tethering is information held by the OS when the access point was activated by tethering in the information processing device 101.

Since the password transmitted by the DPP Configuration is information already held by the OS, it need not be newly inputted by the user on a screen displayed by the setting application. By transmitting the connection information by WEC as in the present embodiment, it is possible to transmit a password to the communication device 151 by secure communication without newly receiving password input from the user on a screen displayed by the setting application. Also, in the DPP Configuration, communication is executed using the DPP. After step S411, the process of FIG. 4 is terminated.

The contents of the process of FIG. 4 are not limited to the above-described contents. For example, the capabilities of the communication device 151 may be included in the WEC-related information obtained from the communication device 151 in the process of step S202 rather than being obtained by the authentication process.

As described above, in the present embodiment, when there is a possibility that the communication device 151 can be connected to a predetermined setting target access point, the connection information of the predetermined access point is transmitted to the communication device 151 by WEC. Further, when there is no possibility that the communication device 151 can be connected to a predetermined setting target access point or a user operation of input of a password of the access point is necessary, an access point is activated by tethering of the information processing device 101. Then, the connection information of the access point activated by tethering is transmitted by WEC to the communication device 151.

That is, by a configuration in which a network setup is performed using tethering when a procedure such as that in which the user is prompted to input the password of an access point would occur, it is possible to realize a simple setup in which password input by the user and the like is omitted.

In the above-described embodiment, a description has been given for performing processes of activating an access point by tethering and obtaining and determining information related to wireless settings according to a function of the OS; however, the present invention is not limited to such a configuration. For example, a configuration may be taken such that the setting application executes these processes. Further, the determination process is not limited to the configuration in which it is executed by the OS or the setting application; a configuration may be taken so as to display a determination result on a screen to the user to receive an instruction for executing the process from the user.

In the above-described embodiment, an authentication method and a frequency band of an accessible access point have been given as the capabilities of the communication device 151; however, the present invention is not limited to these. For example, they may be information necessary for the functions that can be executed by the communication device 151. Specifically, if it is required that the communication device 151 be connected to the Internet, information that Internet communication is necessary may be included in the capabilities among the functions that can be executed by the communication device 151. For example, if Internet communication is necessary, in step S403, it is further determined whether Internet communication can be executed with the access point to which the information processing device 101 is connected, and only when it can be executed, the process proceeds to step S404. In addition, in step S406, only the access points that can execute Internet communication are listed from the list of connectable access points. In doing so, it becomes possible to prevent the functions of the communication device 151 from being restricted due to connecting the communication device 151 to an access point that cannot execute Internet communication.

In the present embodiment, a description has been given that the WEC-related information is obtained from a QR code in step S202; however, the present invention is not limited to such a configuration. For example, the WEC-related information may be obtained from the communication device 151 via short-range wireless communication, such as Near Field Communication (NFC) and Bluetooth Low Energy (BLE). Further, it may be obtained via a Wi-Fi connection between the access point enabled by the communication device 151 operating in the network setup mode and the information processing device 101.

In the present embodiment, a description has been given for a form in which information of an access point is not transmitted to the communication device 151 when NO in step S201 or S203; however, the present invention is not limited to this form. A form may be taken such that if NO in step S201 or S203, the communication device 151 transmits access point information by a method other than WEC. For example, the communication device 151 can operate in a network setup mode, which is a mode for executing a network setup of the communication device 151, by receiving a predetermined operation from the user. When operating in the network setup mode, the communication device 151 uses the communication unit 156 to operate as an enabled setup access point while operating in the network setup mode. It is assumed that an SSID of the setup access point includes a predetermined character string that can be recognized by the setting application of the information processing device 101. It is also assumed that the setup access point is an access point that does not require a password for connection. It is assumed that the communication device 151 operating in the network setup mode uses a predetermined communication protocol (setup communication protocol) in the communication with the information processing device 101 connected to the setup access point. Specifically, the setup communication protocol is, for example, a Simple Network Management Protocol (SNMP). Then, it is assumed that if NO in step S201 or S203, the information processing device 101 connects to the communication device 151, which is operating in the network setup mode. The information processing device 101 may transmit the information of the access point to the communication device 151 by the SNMP via a connection with the communication device 151, which is operating in the network setup mode. The information transmitted at this time is, for example, information of an access point to which the information processing device 101 had been connected immediately before being connected to the communication device 151, which is operating in the network setup mode. Further, for example, it may be a list of access points found by the information processing device 101 by a search or information of an access point selected by the user from a list of access points found by the communication device 151 by a search. Further, for example, the information processing device 101 may receive information for connecting to the communication device 151, which is operating in the AP mode, by the SNMP via a connection with the communication device 151, which is operating in the network setup mode. The AP mode is a mode in which an access point different from the access point enabled in the above-described network setup mode is enabled. The information processing device 101 may use the received information to terminate the network setup mode connect to the communication device 151, which is operating in the AP mode.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-179731, filed Nov. 2, 2021, which is hereby incorporated by reference herein in its entirety.

What is claimed is:

1. A method comprising:
executing first process for a communication, between an information processing device and a communication device, for establishing, between an access point that is different from the communication device and the communication device, a wireless connection by a predetermined connection method, wherein information of the access point is transmitted to the communication device in the communication;
in a case where there is no external access point that is different from the information processing device and to which the information processing device is able to connect, setting the information processing device to operate as an access point and executing second process for transmitting information of the access point as which the information processing device is operating.

2. The method according to claim 1, further comprising
determining whether or not there is an external access point that is currently connected to the information processing device,
wherein, in a case where it is determined that there is the external access point that is currently connected, the external access point that is currently connected is determined as the access point corresponding to the transmitting.

3. The method according to claim 2, wherein in a case where it is determined that there is no access point that is currently connected, the information processing device is set as an access point and the set access point is determined as the access point corresponding to the transmitting.

4. The method according to claim 1, further comprising
searching for an external access point neighboring the information processing device, and
determining whether or not there is an external access point that satisfies a condition among found external access points,
wherein, in a case where it is determined that there is the external access point that satisfies the condition, the external access point that satisfies the condition is determined as the access point corresponding to the transmitting.

5. The method according to claim 4, wherein the condition includes that information of the found external access point is stored as a history in the information processing device.

6. The method according to claim 4, wherein in a case where it is determined that there is no access point that satisfies the condition, the information processing device is set as an access point and the set access point is determined as the access point corresponding to the transmitting.

7. The method according to claim 1, wherein the information of the access point includes at least one of an SSID and a password.

8. The method according to claim 1, wherein the information processing device is set as an access point that is activated by tethering.

9. The method according to claim 1, further comprising
obtaining information that is used for the communication for establishing the wireless connection by the predetermined connection method,
wherein, the communication for establishing the wireless connection by the predetermined connection method is executed using the obtained information.

10. The method according to claim 9, wherein the information that is used for the communication for establishing the wireless connection by the predetermined connection method is obtained from the communication device via a wireless connection by a connection method that is different from the predetermined connection method.

11. The method according to claim 10, wherein the wireless connection by the connection method that is different from the predetermined connection method is a connection by a short-range wireless communication.

12. The method according to claim 9, wherein the information that is used for the communication for establishing the wireless connection by the predetermined connection method is obtained by capturing code information displayed on a display unit of the communication device.

13. The method according to claim 1, further comprising
determining whether or not the communication to be executed is possible in the information processing device,
wherein, in a case where it is determined possible, the communication is executed.

14. The method according to claim 1, wherein the communication to be executed is a communication executed by a Device Provisioning Protocol (DPP).

15. The method according to claim 1, wherein the first process is activating a predetermined function, for transmitting the information of the access point, according to a function of OS of the information processing device.

16. The method according to claim 1, wherein the second process is displaying a screen prompting the user to transmit information of the access point as which the information processing device is operating.

17. A non-transitory computer-readable storage medium storing a program configured to cause a computer to:
execute first process for a communication, between an information processing device and a communication device, for establishing, between an access point that is different from the communication device and the communication device, a wireless connection by a predetermined connection method, wherein information of the access point is transmitted to the communication device in the communication;
in a case where there is no external access point that is different from the information processing device and to which the information processing device is able to connect, set the information processing device to operate as an access point and execute second process for transmitting information of the access point as which the information processing device is operating.

18. An information processing device comprising:
an execution unit configured to execute first process for a communication, between an information processing device and a communication device, for establishing, between an access point that is different from the communication device and the communication device, a wireless connection by a predetermined connection method, wherein information of the access point is transmitted to the communication device in the communication;
in a case where there is no external access point that is different from the information processing device and to which the information processing device is able to connect, a setting unit configured to set the information processing device to operate as an access point and execute second process for transmitting information of the access point as which the information processing device is operating.
